(19) United States
(12) Patent Application Publication
(10) Pub. No.: US 2009/0153631 A1
(43) Pub. Date: Jun. 18, 2009

(54) INKJET PRINTER

(76) Inventor: Shr-How HAUNG, Taoyuan County (TW)

Correspondence Address: BIRCH STEWART KOLASCH & BIRCH, PO BOX 747, FALLS CHURCH, VA, 22040-0747, US

(21) Appl. No.: 12/333,083

(22) Filed: Dec. 11, 2008

(30) Foreign Application Priority Data
Dec. 14, 2007 (TW) 96148022

(51) Int. Cl. B41J 2/175

(52) U.S. Cl. 347/86; 347/108

(57) ABSTRACT

An inkjet printer includes a carrier carrying a print head and is capable of sliding reciprocally along a path, an ink reservoir, a plurality of ink tubes, a holding seat and a pivot member. The reservoir supplies ink to the print head via the ink tubes. Each of plurality of ink tubes has two opposite portions connected to the ink reservoir and the print head respectively. The pivot member is mounted rotatably on the holding seat, and has a clamping unit. The ink tubes further have a plurality of tube sections between the opposite portions and clamped securely by the clamping unit.

### BACKGROUND OF THE INVENTION

1. Field of the Invention

The invention relates to a pivot member, more particularly to a pivot member that is used for securing an ink-supplying tube unit within an inkjet printer such that the ink-supplying tube unit interconnects a print head to an ink reservoir within the inkjet printer.

2. Disclosure of the Related Art

Referring to FIGS. 1A and 1B, a conventional inkjet printer (such as model HP 8250) is shown to include a carrier 11, a print head 12, an ink reservoir 14 and a flexible ink-supplying tube unit 15.

The print head 12 is mounted on the carrier 11 that slides reciprocally along a path 13 within the inkjet printer so as to permit the print head 12 to perform a printing operation on a paper sheet while traveling along the path 13. The ink-supplying tube unit 15 has two opposite ends connected to the print head 12 and the ink reservoir 14 respectively for supplying ink to the print head 12. The encircled portion shows a cross-sectional view taken along lines a-a′ of FIG. 1A, wherein the ink-supplying tube unit 15 consists of four minor tubes 152.

The conventional inkjet printer further includes a first fixing element 16, a second fixing element 17 and a swing rod 18. The first fixing element 16 is mounted on the carrier 12 in order to secure one end of the ink-supplying tube unit 15 while the second fixing element 17 is mounted on the ink reservoir 14 so as to secure the other end of the ink-supplying tube unit 15 with respect to the reservoir 14. The swing rod 18 has two opposite ends connected to the ink-supplying tube unit 15 and the reservoir 14 in such a manner that reciprocal movement of the carrier 11 along the path 13 results in bending action of the ink-supplying tube unit 15, which in turn, results in swinging of the swing rod 18 with respect to the ink reservoir 14. Due to reciprocal swinging of the rod 18, the ink-supplying tube unit 15 is prevented from over folding and twisting action that may tend to ruin or damage.

The conventional inkjet printer has the following disadvantages:
(I) The second fixing element 17 and the swing rod 18 are independently formed, thereby increasing the components and consequently resulting in additional assembly and manufacturing expense;
(II) The cost of constructing the ink-supplying tube unit is relatively high;
(III) Once the carrier 11 is slid to the maintenance position (the rightmost end), the ink-supplying tube unit 15 possesses a relatively small bending radius R due to restriction of the first and second fixing elements 16, 17, thereby causing increased resistance to Ink flow from the reservoir 14. Another motor is required to drive the ink from the reservoir to the print head;
(IV) The ink-supplying tube unit 15 possesses a large variance of bending radius due to restriction of the first and second fixing elements during reciprocal movement of the carrier 11. The force applied by the ink-supplying tube unit 15 on the carrier 11 becomes unstable because the ink-supplying tube unit 15 possesses a large variance of bending radius. Under such condition, the carrier 11 may slide in a wobble and unbalance manner, which, in turn, may affect the stable printing of the print head; and
(V) Since the reservoir 14 is bitten continuously by the ink-supplying tube unit 15 when the carrier 11 slides to the rightmost side of the inkjet printer, the service life of the ink-supplying tube unit 15 is shortened accordingly.

### SUMMARY OF THE INVENTION

The first object of the present invention is to provide an inkjet printer, in which, the ink tube unit can maintain a stable bending radius during sliding action of the carrier holding the print head within the inkjet printer.

The other object of the present invention is to provide an inkjet printer, in which, the ink tube unit has a relatively low resistance against the ink flow during sliding action of the carrier within the inkjet printer.

Another object of the present invention is to provide an inkjet printer, in which, the ink tube unit is fixed within a predetermined range along the Z-axis such that the same will not tangled up during sliding action of the carrier within the inkjet printer.

In one aspect of the present invention, an inkjet printer is provided to include a print head, a carrier, an ink reservoir, a plurality of ink tubes, a holding seat and a pivot member. The carrier is used for carrying the print head thereon, and is capable of sliding reciprocally within the inkjet printer. The reservoir supplies ink to the print head. Each of plurality of ink tubes has two opposite portions connected to the ink reservoir and the print head respectively. The pivot member is mounted rotatably on the holding seat, and has a clamping unit, wherein the ink tubes further have a plurality of tube sections between the opposite portions and clamped securely by the clamping unit.

In a second aspect of the present invention, a pivot member is provided for use within an inkjet printer that includes a print head, a carrier, an ink reservoir, a plurality of ink tubes and a holding seat. The carrier is used for carrying the print head thereon, and is capable of sliding reciprocally within the inkjet printer. The reservoir supplies ink to the print head. Each of plurality of ink tubes has two opposite portions connected to the ink reservoir and the print head respectively. The pivot member is mounted rotatably on the holding seat, and has a clamping unit, wherein the ink tubes further have a plurality of tube sections between the opposite portions and clamped securely by the clamping unit.

### BRIEF DESCRIPTION OF THE DRAWINGS

Other features and advantages of this invention will become more apparent in the following detailed description of the preferred embodiments of this invention, with reference to the accompanying drawings, in which:

FIGS. 1A and 1B respectively show a conventional inkjet printer in operation;

FIGS. 2A to 2E respectively show an inkjet printer of the present invention in operation;

FIGS. 3A to 3E respectively show different pivot members employed in the inkjet printer of the present invention.

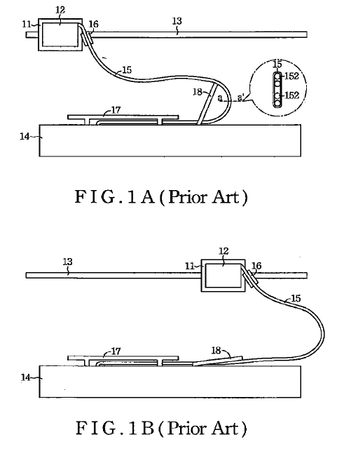

### DETAILED DESCRIPTIONS OF THE PREFERRED EMBODIMENTS

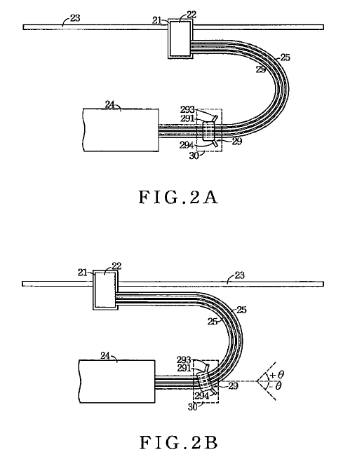

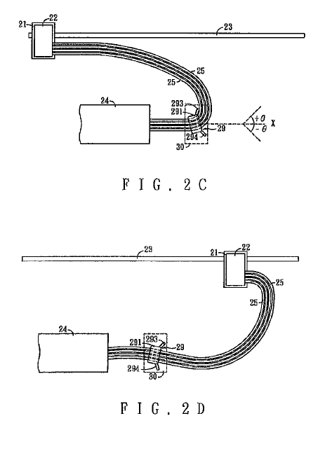

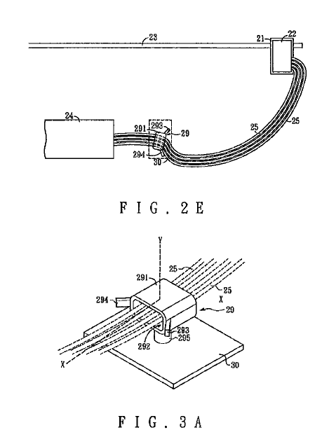

FIGS. 2A to 2E respectively show top planar views of the first embodiment of a printer according to the present invention to include a print head 22, a carrier 21, an ink reservoir 24, a plurality of ink tubes 25, a holding seat 30 and a pivot member 29. The present printer can be an inkjet printer, a multi-function fax machine, a multi-function printer or a multi-function copier.

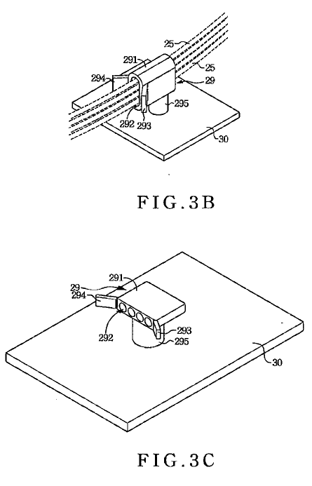

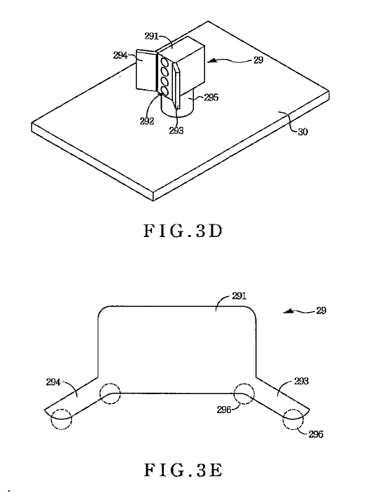

The print head 22 is mounted on the carrier 21 that is capable of sliding reciprocally within the inkjet printer along a predetermined direction h 23 (such as a path or a rack) so that the print head 22 can perform printing operation onto a paper sheet while traveling along the path 23. The ink reservoir 24 is used for supplying ink to the print head 22. Each of the ink tubes 25 has two opposite portions connected to the ink reservoir 24 and the print head 22 respectively so as to supply the ink from the reservoir 24 to the print head 22. The pivot member 29 is mounted rotatably on the holding seat 30 (see FIG. 3A) and has a clamping unit 291 in the form of a tube. The ink tubes 25 further have a plurality of middle tube sections between the opposite portions and are clamped securely by the clamping unit 291.

The carrier 21 slides reciprocally along the predetermined direction 23 to left and right sides thereof in order to permit the print head 22 to perform the printing operation upon the paper sheet (not shown). Since the plurality of the middle tube sections are clamped securely by the clamping unit 291 of the pivot member 29, the tubes 25 swing reciprocally to the left and right sides of the path 23 due to sliding action of the carrier 21 along the path 23, thereby causing turning and simultaneous rotation of the pivot member 29 with respect to the holding seat 30. Under this condition, the tubes 25 can maintain a relatively large curvature radius.

As shown, the carrier 21 slides reciprocally along the predetermined direction 23 such that the pivot member 29 is turnable about a first axis X parallel to the predetermined direction 23 and simultaneously rotate about a second axis Y (see FIG. 3A) perpendicular to the first axis X. As illustrated in FIG. 2C, when the carrier 21 reaches the leftmost side of the path 23 the pivot member 29 turns left side of the first axis X and extends inclinedly to define +45 degree angle. As Illustrated in FIG. 2D, when the carrier 21 reaches the rightmost side of the path 23, the pivot member 29 turns right side of the first axis X and extends inclinedly to define −45 degree angle (shown by +θ and −θ in FIG. 2C).

FIG. 3A shows one modification of the pivot member 29 employed in the printer of the present invention. The pivot member 29 further includes a mounting post 295 that is integrally formed with the clamping unit 291, that is mounted rotatably on the holding seat 30, and that extends along a second axis Y perpendicular to the first axis X. Note that the holding seat 30 can be mounted on the bottom or roof the printer. As shown in FIG. 3A, the holding seat 30 is mounted on the bottom of the printer such that the clamping unit 291 is located above the mounting post 295. In the event, the holding seat 30 is installed to the top of the printer, the clamping unit 291 is located below the mounting post 295.

FIGS. 3A to 3E respectively show different modifications of the pivot member employed in the printer of the present invention, wherein each pivot member 29 includes a mounting post 295 mounted rotatably on the holding seat 30 and a clamping unit 291 fixed to or integrally formed with the post 295.

FIG. 3A shows a first modification of the pivot member 29, wherein the clamping unit 291 defines a holding channel 292 extending along a first axis X parallel to the path 23. The holding channel 292 has a width greater than the height and permitting extension of the plurality of middle tube sections of the ink tubes 25. The plurality of middle tube sections of the ink tubes 25 are arranged to extend along a horizontal direction (also the first axis) within the holding channel 292 in the clamping unit 291.

FIG. 3B shows a second modification of the pivot member 29, wherein the clamping unit 291 defines a holding channel 292 having a width smaller than the height and permitting extension of the plurality of tube sections of the ink tubes 25. The tube sections of the ink tubes 25 are stacked above one another along a vertical direction.

FIG. 3C shows a third modification of the pivot member 29, wherein the clamping unit 291 defines a plurality of holding channels 292. Each of the holding channels 292 extends along a horizontal direction (also the first axis) and permitting extension of a respective one of the plurality of tube sections of the ink tubes 25.

FIG. 3D shows a fourth modification of the pivot member 29, wherein the clamping unit 291 defines a plurality of holding channels 292. Each of the holding channels 292 is stacked above one another to extend along a vertical direction and permitting extension of a respective one of the plurality of tube sections of the ink tubes 25.

The pivot member 29 further has a first limit portion 293 extending inclinedly to right side of the first axis X.

Referring again to FIGS. 2A to 2C, during the reciprocal sliding of the carrier 21 within the printer of the present invention, when the carrier 21 is moved to the leftmost side (see FIG. 2C) of the path 23 from the middle printing position (shown in FIG. 2A), the pivot member 29 is consequently turned in the left side of the first axis X due to co-movement of the ink tubes 25 with the carrier 21. Note that turning of the pivot member 29 to the left side is caused since the force generated due to co-movement of the ink tubes 25 together with the carrier 21 is applied either on the clamping unit 291 or the first limit portion 293 of the pivot member 29.

Under this condition, the ink tubes 25 can maintain a relatively large radius during turning of the pivot member 29 to the left side of the first axis X.

Referring to FIG. 2C, once the carrier 21 is moved to the leftmost side of the path 23, the ink tubes 25 are prevented by the first limit portion 293 of the pivot member 29 from further bending. In other words, the first limit portion 293 is used to prevent over bending or twisting of the ink tubes 25 so as to avoid the occurrence of the over resistance that hinders the ink flow from the reservoir to the print head. The tube 25 can maintain a sufficient curvature radius due to presence of the first limit portion 293 in the pivot member 29.

The pivot member 29 further has a second limit portion 294 extending inclinedly to the right side of the first axis X.

Referring again to FIGS. 2A, 2D and 2E, during the reciprocal sliding of the carrier 21 within the printer of the present invention, when the carrier 21 is moved to the rightmost side (shown in FIG. 2E) of the path 23 from the middle printing position (shown in FIG. 2A), the pivot member 29 is consequently turned to the right side of the first axis X due to co-movement of the ink tubes 25 with the carrier 21. Note that turning of the pivot member 29 to the right side is caused since the force generated due to co-movement of the ink tubes 25 together with the carrier is applied either on the clamping unit 291 or the second limit portion 294 of the pivot member 29.

Under this condition, the ink tubes 25 can maintain a relatively large radius during turning of the pivot member 29 to the right side of the first axis X.

Referring to FIG. 2E, once the carrier 21 is moved to the rightmost side of the path 23, the ink tubes 25 are prevented by the second limit portion 294 of the pivot member 29 from further bending. In other words, the second limit portion 294 is used to prevent over bending or twisting of the ink tubes 25 so as to avoid the occurrence of the over resistance that hinders the ink flow from the reservoir to the print head. The tube 25 can maintain a sufficient curvature radius due to presence of the second limit portion 293 in the pivot member 29.

In one preferred embodiment, the carrier 21 slides reciprocally along the predetermined direction 23 to left and right sides thereof, wherein the aforesaid first axis X is parallel to the path 23. Under this condition, the first limit portion 293 extends inclinedly to the left side of the first axis X to define +45 degree angle therebetween. The second limit portion 294 extends inclinedly to the right side of the first axis X to define −45 degree angle therebetween.

Moreover, each first and second limit portions 293, 294 of the above pivot member 29 has a free end 296 (shown by an encircled portion in FIG. 3E) distal to the clamp unit 291, and an connection end 296 (shown by an encircled portion in FIG. 3E) proximate to the clamp unit 291. The free ends 296 of the first and second limit portions 293, 294 as well as the connection ends 296 may cause folding and bending of the ink tubes 25 when the carrier 21 reciprocally slides action of along the path 23.

FIG. 3E shows a top planar view of the above pivot member 29, wherein each free end 296 of the first and second limit portions 293, 294 of the above pivot member 29 is formed with a curved surface and the connection end 296 is formed with a curved surface. When thus arranged, the ink tubes 25 are prevented from over bending, folding and twisting, thereby lowering the resistance of the inflow from the ink reservoir 24 to the print head 22.

The printer of the present invention provides the following advantages:
(I) Each of the middle tube sections is secured within the respective holding channel 292 in the clamping unit 291, thus is limited within a predetermined range. Under this condition, the ink tubes 25 will not tangled up due to reciprocal sliding action of the carrier 21 along the predetermined direction 23:
(II) Since the pivot member 29 is mounted rotatably on the holding seat 30, the pivot member 29 is turnable to the left side of the first axis X to define +45 degree angle therebetween, during which the pivot member 29 simultaneously rotates about the second axis Y perpendicular to the first axis X. In addition, the pivot member 29 is further turnable to the right side of the first axis X to define −45 degree angle therebetween, during which the pivot member 29 simultaneously rotates about the second axis Y perpendicular to the first axis X. Therefore, it can be assumed that the ink tubes 25 is limited within a relatively large bending radius during reciprocal sliding action of the carrier 21 along the predetermined direction 23;
(III) The printer head provides fine printing effect since the force applied by the ink tubes 25 onto the carrier 21 is uniform during sliding action of the carrier 21 along the predetermined direction 23;
(IV) Since there is low resistance to the flow of ink, no extra motor is required for transferring the ink from the ink reservoir 24 to the print head 22; and
(V) Because the pivot member 29 is rotatable relative to the holding seat 30 (i.e. the mounting post 295 is rotatable about the second axis Y), deformation and tangle up of the ink tubes 25 is prevented during sliding action of the carrier 21 along the predetermined direction 23.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An inkjet printer comprising:
a print head;
a carrier for carrying said print head thereon and slidable within the inkjet printer along a predetermined direction;
an ink reservoir for supplying ink to said print head;
a plurality of ink tubes having two opposite portions connected to said ink reservoir and said print head respectively;
a holding seat; and
a pivot member mounted rotatably on said holding seat, and having a clamping unit, wherein said ink tubes further have a plurality of middle tube sections between said opposite portions and clamped by said clamping unit.

2. The inkjet printer according to claim 1, wherein said clamping unit defines a holding channel permitting extension of said plurality of tube sections of said ink tubes.

3. The inkjet printer according to claim 2, wherein said plurality of middle tube sections of said ink tubes are arranged along a horizontal direction within said holding channel in said clamping unit.

4. The inkjet printer according to claim 2, wherein said plurality of middle tube sections are stacked above one another along a vertical direction.

5. The inkjet printer according to claim 2, wherein said holding channel of said clamping unit extends along a first axis parallel to said predetermined direction, said pivot member further having a first limit portion extending from said clamping unit to form an first angle relative to said first axis, said first angle being greater than 0 degree

6. The inkjet printer according to claim 5, wherein said pivot member further has a second limit portion extending from said clamping unit to form a second angle relative to said first axis, said second angle being greater than 0 degree.

7. The inkjet printer according to claim 6, wherein each of said first and second limit portions has a free end distal to said clamp unit and formed with a curved surface, and an connection end proximate to and cooperating with said clamp unit to form an adjoining area formed with a curved surface.

8. The inkjet printer according to claim 6, wherein said first angle is substantially +45 degree relative to the first axis, and said second angle is substantially −45 degree relative to the first axis.

9. The inkjet printer according to claim 1, wherein said clamping unit defines a plurality of holding channels, each of said holding channels arranged to extend along a first axis parallel to said predetermined direction and permitting extension of a respective one of said plurality of middle tube sections of said ink tubes.

10. The inkjet printer according to claim 9, wherein said pivot member further has a first limit portion extending from said clamping unit to form an first angle relative to said first axis, said first angle being greater than 0 degree.

11. The inkjet printer according to claim 10, wherein said pivot member further has a second limit portion extending from said clamping unit to form a second angle relative to said first axis, said second angle being greater than 0 degree.

12. The inkjet printer according to claim 11, wherein each of said first and second limit portions has a free end distal to said clamp unit and formed with a curved surface, and an connection end proximate to and cooperating with said clamp unit to form an adjoining area formed with a curved surface.

13. The inkjet printer according to claim 11, wherein said first angle is substantially +45 degree relative to the first axis, and said second angle is substantially −45 degree relative to the first axis.

14. The inkjet printer according to claim 1, wherein said clamping unit define a plurality of holding channels, each of said holding channels extending along a first axis parallel to said predetermined direction and further being stacked one above another along a vertical direction and permitting extension of a respective one of said plurality of middle tube sections of said ink tubes.

15. The inkjet printer according to claim 14, wherein said pivot member further has a first limit portion extending from said clamping unit to form a first angle relative to said first axis, said first angle being greater than 0 degree.

16. The inkjet printer according to claim 15, wherein said to pivot member further has a second limit portion extending from said clamping unit to form a second angle relative to said first axis, said second angle being greater than 0 degree.

17. The inkjet printer according to claim 16, wherein each of said first and second limit portions has a free end distal to said clamp unit and formed with a curved surface, and an connection end proximate to and cooperating with said clamp unit to form an adjoining area formed with a curved surface.

18. The inkjet printer according to claim 16, wherein said first angle is substantially +45 degree relative to the first axis, and said second angle is substantially −45 degree relative to the first axis.

19. The inkjet printer according to claim 1, wherein said clamping unit of said pivot member extends along a first axis parallel to said predetermined direction and is further rotatable on said holding seat about a second axis perpendicular to said first axis.

20. The inkjet printer according to claim 19, wherein said clamping unit of said pivot member is rotatable about said second axis between +45 degree and −45 degree.
